(19) United States
(12) Patent Application Publication
(10) Pub. No.: US 2022/0330524 A1
(43) Pub. Date: Oct. 20, 2022

(54) PET TREAT HOLDER AND DISPENSING SYSTEM

(71) Applicant: Rafael Villanova Mattos, Deerfield Beach, FL (US)

(72) Inventor: Rafael Villanova Mattos, Deerfield Beach, FL (US)

(21) Appl. No.: 17/230,946

(22) Filed: Apr. 14, 2021

(51) Int. Cl. A01K 15/02

(52) U.S. Cl. CPC A01K 15/026

(57) ABSTRACT

A pet treat holder and dispensing system to be used preferably with rigid and semi-rigid pet treats is disclosed. The pet treat holder and dispensing system is used to protect a pet from choking on a pet treat and other hazards, keep the pet treat in one place and provide a protective shield around the pet treat that makes it more conducive to the pet's enjoyment. The pet treat holder and dispensing system includes a housing having a transverse mouth opening therethrough and inner and outer portions. The housing is sized and shaped to facilitate access by a pet to a pet treat that is received and kept inside in the transverse mouth opening. A support located and attached to a bottom part in the inner portion of housing is also in the pet treat holder and dispensing system, the support having bottom and upper portions and including an oval shaped finger support part in the upper portion. The support allows the holding by a person of the pet treat in the transverse mouth opening.

### FIELD OF INVENTION

The present invention relates to pet treat holder and dispensing systems and, more particularly, to pet treat holder and dispensing systems for rigid and semi-rigid pet treats.

### BACKGROUND OF THE INVENTION

Although pet treats are extremely popular with both owners and pets alike, they are usually held, offered, and dispensed with some trepidation. In addition, pet treats tend to be almost impossible to swallow when they are full sized.

The real concern about the handling of pet treats is augmented when pieces are chewed off and their lengths diminish. Some pets, especially larger pets, chew a six inch treat down to two inches or so, and attempt to swallow the entire remaining portion.

If the pet is successful in chewing a treat down to a large size, one or more of the following four scenarios may happen including (1) leaving the pet with a solid mass in its stomach that cannot be readily digested, which it will regurgitate 24-48 hours later, (2) the pet experiencing significant distress and needing a veterinary visit to remedy, (3) the pet getting the treat lodged in its throat and needing veterinary assistance to safely remove it, and (4) the pet choking and dying. Thus, some pet owners habitually hold the treat in their hand and never allow their pet to chew freely because of a fear of choking.

Depending on the size and volition of the animal, the pet treat is usually not quickly consumed. Some pets can take hours or days to completely ingest a treat. Some finish it in one sitting and others need several sittings. Regardless, a pet with a treat does not always display behaviors that are consistent with the owner's wishes. Such behaviors may include (a) taking the treat and chewing it on the couch, on the rug, on top of an owner's clothes, towels or bed, (2) attempting to hide the treat in the couch, behind the couch, backyard, under the rug, or some other inconvenient, inaccessible place, where it will rot and stink, (3) on a serious note, having a conflict with another pet in the house considering that a dog's personality often changes when it has a treat or bone, and (4) on an even more serious note, possibly snapping at or even biting an owner or child who comes too close to its treat.

The value of a treat is also lost when it is not fully consumed because it is hidden or lost, which wastes money on treats that usually cost between $1.00 to over $10.00 each.

Thus, there is a need for a pet treat holder and dispensing system that holds a treat and allows the pet to safely take it therefrom.

### SUMMARY

An object of the present invention is to provide a pet treat holder and dispensing system that holds a treat and allows a pet to safely take it therefrom.

### BRIEF DESCRIPTION OF THE DRAWINGS

The above-mentioned and other features of the invention disclosed herein are described below with reference to the drawings of the preferred embodiments. The illustrated embodiments are intended to illustrate, but not limit, the invention. The drawings contain the accompanying figures:

FIG. 1 illustrates a perspective view of a preferred embodiment of the pet treat holder and dispensing system of the present invention while in use holding a pet treat.

FIG. 2 illustrates a bottom view of a preferred embodiment of the pet treat holder and dispensing system of the present invention.

FIG. 3 illustrates a top view of a preferred embodiment of the pet treat holder and dispensing system of the present invention.

FIG. 4 illustrates a side view of a preferred embodiment of a pet treat holder and dispensing system of the present invention incorporated in a pet toy.

FIG. 5 illustrates a top side view of a preferred embodiment of a pet treat holder and dispensing system of the present invention incorporated in a pet toy.

FIG. 6 illustrates a top view of a preferred embodiment of a pet treat holder and dispensing system of present invention incorporated in a pet toy.

### DETAILED DESCRIPTION OF THE INVENTION

The following disclosure is presented to provide an illustration of the general principles of the present invention and is not meant to limit, in any way, the inventive concepts contained herein. Moreover, the described in this section can be used in combination with the other described features in each of the multitude of possible permutations and combinations contained herein.

All terms defined herein should be afforded broadest possible interpretation, including any meanings as dictated by a reading of the specification as well as any words that a person having skill in the art and/or a dictionary, treatise, or similar authority would assign thereto.

Further, it should be noted that, as recited herein, the singular forms ‘a,’ “an,” and “the” include the plural referents unless otherwise stated. Additionally, the terms “comprise” and “comprising” when used herein specify that certain features are present in that embodiment, however, this phrase should not be interpreted to preclude the presence or additional operations, features, components, and/or groups thereof.

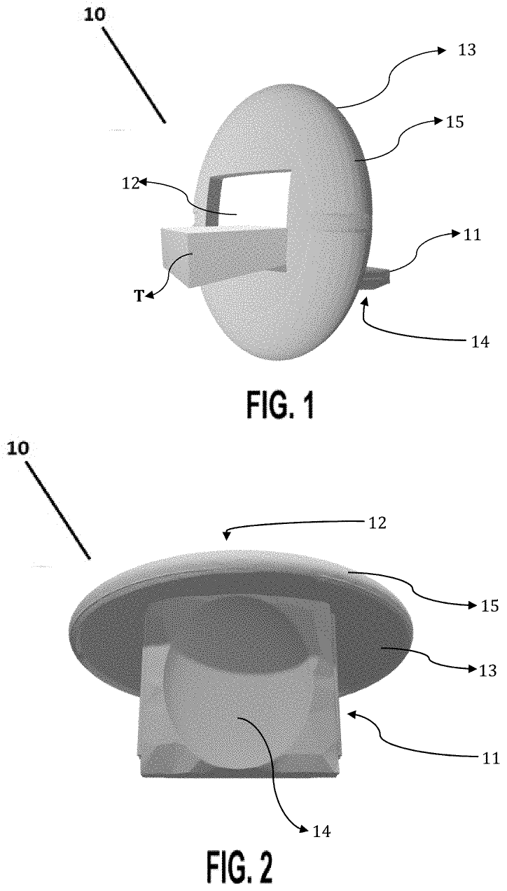

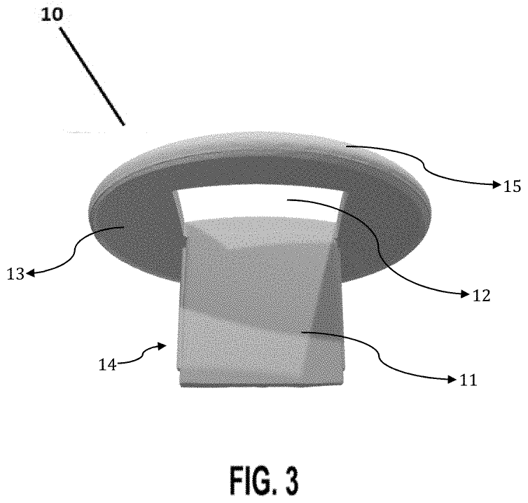

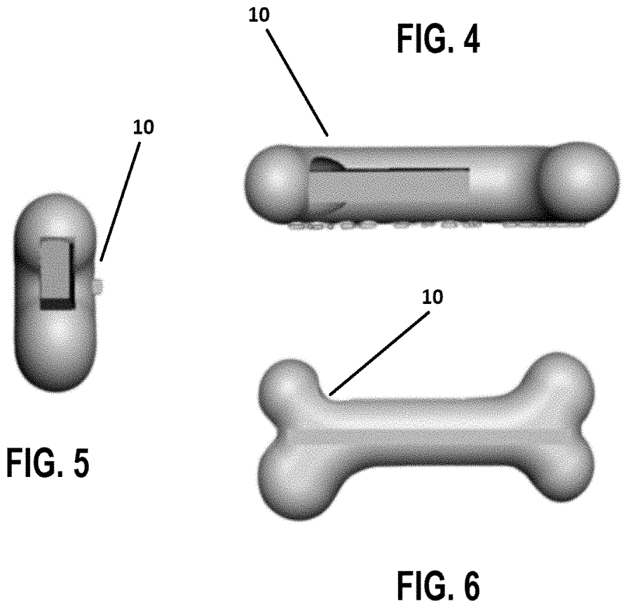

With reference to FIGS. 1 through 6, a pet treat holder and dispensing system 10 is shown holding a pet treat T (FIG. 1), as well as by itself (FIGS. 2-3), and as incorporated in a pet toy (FIGS. 4-6). A pet treat holder and dispensing system 10 includes a housing 15 including a transverse mouth opening 12 therethrough and inner 13 and outer portions, the housing 10 being sized and shaped to facilitate access by a pet to a pet treat T that is received and kept inside in the transverse mouth opening 12. The pet treat holder and dispensing system also includes and a support 11 located and attached to a bottom part in the inner portion 13 of housing 10, the support 11 having bottom and upper portions and including an oval shaped finger support part 14 in the upper portion. The support 11 allows the holding of the pet treat T in the transverse mouth opening 12.

In one of its many preferred embodiments, the inner portion 13 of the housing 15 may be concave shaped and the outer portion of the housing 15 may be convex shield shaped or quadrilateral shaped with rounded corners. The general external shape of the pet treat holder and dispensing system 10 and, particularly, of the housing 15 increases the ability of the pet owner to hold the candy T between his hand.

In a preferred embodiment, the pet treat holder and dispensing system 10 holds conventionally available treats consumed mostly (but not exclusively) by dogs as a pet treat T, but not as a primary food source, and administered by the pet owners. In yet another preferred embodiment, the pet treat holder and dispensing system 10 is used in connection with rigid and semi-rigid pet treats T that are usually 6+ inches long and of a cylindrical shape like a pencil or drumstick. In other preferred embodiments, there is no limit to the length of the pet treat T that can be inserted and kept inside in the transverse mouth opening 12. In yet other preferred embodiments, the pet treat holder and dispensing system 10 can accommodate pet treats T slightly less than an inch in diameter. The pet treats T may have no additives and be completely natural and of varying lengths and widths, even within the same class, i.e., 6-inch, 12-inch, inter alia. In addition, the pet treats T usually may not have even diameters throughout their span.

The pet treat holder and dispensing system 10 is designed to be compact and has no exposed parts that could injure the animal during use. The pet treat holder and dispensing system 10 is preferably sized in proportion to the average size of the pet treat T, for example, about 0.5 inch in diameter and about 6 inches long, to be kept in it and is intended to be as discrete as possible for the pet and fit into its normal chewing routine. In one of its many preferred embodiments, the housing 15 of the pet treat holder and dispensing system 10 may have a diameter of about 2.36 inches, and a thickness of about 0.19 inches, and the transverse mouth opening 12 may have a width of about 1 inch wide, a length of about 1 inch and a thickness of about 0.39 inch.

When in use and holding a pet treat T stick, the pet treat holder and dispensing system 10 may hold only a fraction of the pet treat T stick, preferably, about 0.5 inches, so that most of the pet treat T stick is still available for the pet to enjoy. The pet treat holder and dispensing system 10 and all its components are designed and built to withstand the normal forces generated by a pet when pulling/pushing a fixed object.

When used properly, the pet treat dispensing system holder 10 may prevent pets from choking or swallowing indigestible portions of rigid or semi-rigid pet treats T, keep the pet treat T in one location so as to preclude the pet from removing the pet treat T to consume it in a non-preferential location, keep the pet treat T in one location so as to preclude the pet from misplacing the pet treat T, and provide a base around the pet treat T that makes it more conducive for pet enjoyment.

In one of many of its preferred embodiments, the pet treat holder and dispensing system may have its complete structure and components made of a material that is HP 3D High Reusabilibity PA 11 that produces strong, ductile, functional parts and ecological advantages. PA 11 supports a pressure load of 1800 MPa and a temperature of 365° F. enabling it to be used from a dishwasher to a domestic autoclave.

When in use by itself or as incorporated in a pet toy, the pet treat holder and dispensing system 10 provide further additional functional and operational advantages and benefits including (1) an astringent function of helping to clean the teeth of the pet, (2) prevention of death by asphyxiation since the transverse mouth opening 12 will not allow the insertion and holding of larger sized pet treat T that is larger that the transverse mouth opening itself and considering the size of pet's epiglottis/throat (i.e. if pet treat is larger than transverse mouth opening, then it is going to choke), (3) stomach overload as when a pet owner is holding the pet treat T, the pet owner has a way of assuring that the pet does eat large pieces of the pet treat T considering that pets such as dogs, for example, eat rapidly which may cause bad breath, stomach twisting, death in small dogs and many other ailments, and (4) pet entertainment and distraction as to facilitate the brushing of the pet's teeth.

The embodiments described herein are merely exemplary and that a person skilled in the art may make many variations and modifications without departing from the spirit and scope of the invention. All such variations and modifications are intended to be included within the scope of the invention and the appended claims. Moreover, all statements herein reciting principles, aspects, and embodiments of the invention, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

What is claimed is:

1. A pet treat holder and dispensing system, comprising:
a housing including a transverse mouth opening therethrough and inner and outer portions, the housing being sized and shaped to facilitate access by a pet to a pet treat that is received and kept inside in the transverse mouth opening; and
a support located and attached to a bottom part in the inner portion of housing, the support having bottom and upper portions and including an oval shaped finger support part in the upper portion, the support allowing the holding of the pet treat in the transverse mouth opening.

2. The pet treat holder and dispensing system of claim 1, wherein the inner portion of the housing is concave shaped.

3. The pet treat holder and dispensing system of claim 1, wherein the outer portion of the housing is convex-shield shaped.

4. The pet treat holder and dispensing system of claim 1, wherein the outer portion of the housing is quadrilateral shaped with rounded corners.

5. The pet treat holder and dispensing system of claim 1, wherein the housing and the support are designed and built to withstand the normal forces generated by a pet when pulling or pushing a fixed object.
